(19) United States
(12) Patent Application Publication
(10) Pub. No.: US 2018/0029343 A1
(43) Pub. Date: Feb. 1, 2018

(54) POLYETHYLENE BASED SYNTHETIC PAPER

(71) Applicant: Dow Global Technologies LLC, Midland, MI (US)

(72) Inventors: Jorge C. Gomes, Sao Paulo (BR); Didem Oner-Deliormanli, Bellaire, TX (US); Cagatay K. Berilgen, Freeport, TX (US)

(21) Appl. No.: 15/223,391

(22) Filed: Jul. 29, 2016

(51) Int. Cl. B32B 27/32; B32B 27/08

(52) U.S. Cl. CPC B32B 27/32; B32B 27/08; B32B 2250/03; B32B 2250/242; B32B 2307/722; B32B 2307/75; B32B 2307/518; B32B 2554/00

(57) ABSTRACT

The present invention relates to polyethylene films having properties which makes them suitable for use as synthetic paper. The cast films have in a first and a third layer, each of which is an external layer, and each of which independently comprises a linear polyethylene having a density greater than 0.93 g/cm³ and a melt index greater than or equal to 2.0 g/10 min together with a second layer, which is an internal layer comprising a linear polyethylene having a density greater than or equal to 0.94 g/cm³ and a melt index less than or equal to 1.3 g/10 min.

### FIELD OF THE INVENTION

This invention relates to films and more particularly to cast films having good stiffness attributes together with enhanced optical properties.

### BACKGROUND AND SUMMARY

The term “synthetic paper” refers to plastics film and sheet products having a feel and printability similar to cellulose paper. Synthetic paper is a polymeric material, typically based on polyolefins (for example polyethylene or polypropylene), which is stretched and orientated to form a sheet with the stiffness and feel of cellulose paper. It has been recognized that plastics sheet products of these types can provide an improved alternative to cellulose paper where durability and toughness are required. Plastics sheets produced from polyolefins have several advantages over other plastics since they offer UV resistance, good tear strength, water resistance and the ability to be recycled in many post-consumer waste applications.

Synthetic papers have been produced commercially by the plastics industry for many years and have taken a number of different forms. They have included products having voided (i.e. multicellular) or unvoided structures, some of which have been coated with filler- and/or pigment-containing surface coatings to improve printing qualities. The voiding technique has frequently been used to reduce the density of the synthetic paper produced.

Traditionally, synthetic paper is produced with polyester, polyvinyl chloride (PVC), polypropylene (PP) or polyethylene (PE) resins by using calendaring, cast or blown extrusion processes, followed by biaxially orientation. PP resin gives extra durability over traditional pulp based papers. It is desirable economically to produce synthetic paper with polyethylene, however, to date, it has proven difficult to achieve the stiffness of polypropylene based synthetic paper with polyethylene resins, particularly without significant amounts of added filler. For example PE based synthetic paper exists using high density polyethylene (HDPE) compounded with TiO₂ and calcium carbonate on a twin-screw extruder that directly extrudes film and simultaneous biaxial orientation.

Currently, most synthetic paper tends to be on the order of 200 to 900 microns (eight to 35 mil) thick. It is also desirable to be able to down gauge the structure while maintaining paper-like qualities such as bright whiteness, opacity, water-based ink adhesion, scratch resistance, stiffness, deadfold properties, puncture strength, low coefficient of friction, and more balanced MD/TD strength. Newer paper-like films may have some but not all of these traits—e.g., they may be printable but not as stiff as paper. Typical PE based synthetic paper is HDPE compounded with TiO₂ and calcium carbonate on a twin-screw extruder that directly extrudes film and simultaneous biaxial orientation.

The present disclosure provides multilayer film capable of use for synthetic paper applications which allows down gauging compared to other synthetic paper solutions. The disclosure presents a multilayer cast film comprising at least three layers. A first layer, which is an external layer, comprises a linear polyethylene having a density greater than 0.93 g/cm³ and a melt index greater than or equal to 2.0 g/10 min. A second layer, which is an internal layer, comprises a linear polyethylene having a density greater than 0.94 g/cm³ and a melt index less than or equal to 1.3 g/10 min. A third layer, which is also an external layer, comprises a linear polyethylene having a density greater than 0.93 g/cm³ and a melt index greater than or equal to 2.0 g/10 min. The films of the present disclosure should have overall thickness of at least 100 microns.

### DETAILED DESCRIPTION OF THE INVENTION

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Polyethylene” shall mean polymers comprising greater than 50% by weight of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); and High Density Polyethylene (HDPE). Molecular weight of the polymer, which can be expressed as averages values (Mn, Mw, Mz), is correlated to the polymers melt index as determined according to ASTM D 1238 (2.16 kg, 190° C.).

These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). LDPE resins typically have a density in the range of 0.916 to 0.940 g/cm³.

The term “LLDPE” or “Linear Low Density Polyethylene”, includes both resin made using the traditional Ziegler-Natta catalyst systems as well as single-site catalysts such as metallocenes (sometimes referred to as “m-LLDPE”). LLDPEs contain less long chain branching than LDPEs and includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The Linear PE can be made via gas-phase, solution-phase or slurry polymerization or any combination thereof, using any type of reactor or reactor configuration known in the art, with gas and solution phase reactors being most preferred.

The term “HDPE” or High Density Polyethylene is sometimes used to refer to polyethylenes having densities greater than about 0.940 g/cm³, which are generally prepared with Ziegler-Natta catalysts, chrome catalysts or even metallocene catalysts. Similarly “MDPE” or Medium Density Polyethylene is sometimes used to refer to the subset of polyethylenes which have a density in the range of from about 0.926 to about 0.940 g/cm³).

The following analytical methods are used in the present invention:

Density is determined in accordance with ASTM D-792.

“Melt index” also referred to as “I₂” (or MFR for polypropylene resins) is determined according to ASTM D-1238 (for polyethylene resins 190° C., 2.16 kg; for polypropylene resins 230° C., 2.16 kg).

2% Secant Modulus is determined according to ASTM D-882.

Elmendorf Tear is determined according to ASTM D-1922.

Gloss is determined at a 45° angle according to ASTM D-2457.

Haze of the resulting film refers to the total haze (that is internal haze plus external haze) and is determined according to ASTM D1003.

Tensile properties (Break Stress; Strain at Yield; Stress at Yield; Peak Load) are determined according to ASTM D-638.

Cast Films

In its broadest sense the present invention is a cast film comprising at least the following layers:
a. a first layer comprising a linear polyethylene having a density greater than 0.93 g/cm³ and a melt index greater than or equal to 2.0 g/10 min;
b. a second layer comprising a linear polyethylene having a density greater than 0.94 g/cm³ and a melt index less than or equal to 1.3 g/10 min
c. a third layer comprising a linear polyethylene having a density greater than 0.93 g/cm³ and a melt index greater than or equal to 2.0 g/10 min wherein the first layer and the third layer are each an external layer of the film, and wherein the film has an overall thickness of at least 100 microns.

The polyethylene comprising the third layer may advantageously, but not necessarily, be the same linear polyethylene as the one used in the first layer.

Other layers might be also added depending on the particular cast extrusion machine capabilities in order to deliver specific attributes such as packages with barrier properties or good sealability. These additional layers, however, are in addition to the invention herein described as the inventive films always contain at least three layers with a core layer comprised of one or more linear polyethylenes having a density greater than 0.94 g/cm³ and a melt index less than or equal to 1.3 g/10 min and at least 2 external or skin layers each independently comprising one or more linear polyethylenes having a density greater than 0.93 g/cm³ and a melt index greater than or equal to 2.0 g/10 min.

The cast films of the present disclosure will generally have a total thickness in the range of from about 100, 150, or 175 microns to about 300, 250, 225 or 200 microns.

The second, or core, layer will generally comprise from 30 to 80 percent by weight of the cast film, more preferably from 40 to 70 percent by weight of the cast film. The first and third, or “skin” layers will generally collectively comprise from 20 to 70 percent by weight of the cast film more preferably from 30 to 60 percent by weight of the cast film. It is generally preferred that the third layer be approximately the same thickness as the first layer, and hence it is generally preferred that the third layer and second layer each comprise from 5 to 40 percent by weight of the cast film more preferably from 10 to 30 percent by weight of the cast film. It is also contemplated that the cast film may comprise additional layers. These layers may be selected to provide additional functionality, for example barrier properties or seal ability.

Each of the layers of the films of the present invention will comprise a Medium Density Polyethylene (MDPE) or High Density Polyethylene polymer (HDPE). MDPE and HDPE materials are well known in the art, and in general refer to linear polyethylene materials having a density of up to 0.940 g/cm³ for MDPE and above 0.940 g/cm³ for HDPE. Any type of Linear PE can be used in the present invention. This includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The MDPE or HDPE can be made via gas-phase, solution-phase or slurry polymerization or any combination thereof, using any type of reactor or reactor configuration known in the art, with gas and slurry phase reactors being most preferred. Preferred Linear Polyethylene resins are sold by The Dow Chemical Company, for example, under the trade name DOWLEX™ 2050B and ELITE™ 5960G.

The MDPE and/or HDPE component for use in the first and/or third layers (the external layers) has a density of at least 0.930 g/cm³, preferably at least 0.940 g/cm³. The HDPE component for use in the first or third layers also has a melt index greater than 2.0 g/10 min, more preferably greater than 3.0 g/10 min and lower than 10 g/10 min.

The first and third layers each independently contains from about 80 to 100% of one or more MDPE/HDPE resins meeting the density and melt index limitations, but may also contain other materials. Thus the total composition for use in the first and/or third layer may advantageously comprise from 75 to 98% MDPE/HDPE or from 85 to 90% MDPE/HDPE. It is preferred that all (that is 100%) of the resin used in the second and third layers be MDPE/HDPE resin of the sort mentioned above.

The HDPE component for use in the second layer (the internal or core layer) has a density of at least 0.940 g/cm³, more preferably at least 0.942 g/cm³. The HDPE component for use in the second layer also has a melt index less than 1.3 g/10 min, more preferably less than 1.0 g/10 min. It is generally preferred that the density of the material which is used in the first and/or third layers be the same or lower than the density of the material which is used in the second layer. In some preferred embodiments, the difference in density between the second layer and the first and/or second layers is at least 0.001 g/cm³, 0.002 g/cm³, 0.01 g/cm³ or even 0.02 g/cm³.

The second layer preferably contains from about 50 to 100% of one or more HDPE meeting the density and melt index limitations, but may also contain other materials. Thus the total composition for use in the second layer may advantageously comprise from 75 to 98% HDPE or from 85 to 90% HDPE. One polymer which may advantageously be added to the core layer in a minor amount is a high pressure low density type resin known in the industry as Low Density Polyethylene or LDPE. LDPE having a density in the range of 0.917 to 0.935 g/cm³, preferably 0.920 to 0.929 g/cm³ are preferred. It is also preferred that the LDPE have a melt index of from 0.1 to 5.0 g/10 min, more preferably from 0.3 to 2.0 g/10 min. While the second layer of the present invention may contain as much as 50 percent by weight LDPE, it is preferred that the second layer comprise from 2-20 percent LDPE, more preferably from 5 to 15% LDPE.

The cast films of the present invention can be made by conventional cast film methods as is generally known in the art. While not necessary for practice of the present invention, it is possible to subject the films to post-extrusion mono- or biaxial orientation. In some embodiments the films of the present invention may be advantageously stretched at least 50%, preferably at least 100% in the machine and/or cross directions.

As is generally known in the art, each of the layers may include additives, such as pigments, inorganic fillers, UV stabilizers, antioxidants, slip or antiblock additives, etc. It may be desirable to limit the amount of filler contained in the films of the present disclosure. For example, it may be desirable that the films contain less than 5% (by weight of the total film) filler, more preferably less than 3%, or even 1% or less.

The cast films of the present invention will be marked by high stiffness as evidenced by their 2% secant modulus. Preferably the films will have a 2% secant modulus of at least 300 MPa (about 43,500 psi), 350 MPa (about 50,700 psi), 400 MPa (about 58,000 psi) or even greater than or equal to 450 MPa (about 65,200 psi).

The cast films of the present invention will also be characterized by having a relatively high Tensile strength at Break Stress. Preferably the films will have a Tensile/Break Stress of at least 10 MPa (about 1450 psi), 15 MPa (about 2200 psi), 20 MPa (about 2900 psi), 25 MPa (about 3600 psi) or even 30 MPa (about 4300 psi).

The cast films of the present invention will also be characterized by having a relatively high Tensile Strain at Yield. Preferably the films will have a tensile strain at yield of at least 6%, 8%, or even 10%.

The cast films of the present invention will also be characterized as having a relatively high Tensile Stress at Yield. Preferably the films will have a tensile stress at yield of 10 MPa (about 1450 psi), or even 15 MPa (about 2200 psi).

The cast films of the present invention will also be characterized as having a relatively high tensile Strength at Peak Load. Preferably the films will have a tensile strength at peak load of 45 N (about 10 lbf), 65 N (about 15 lbf) 85 N (about 19 lbf), or even 110N (about 25 lbf).

The cast films of the present invention will also have relatively high gloss values. Preferably the gloss at 45° of the films will be at least 30%, more preferably at least 40%.

The cast films of the present invention may also be characterized by its Elmendorf Tear values. In many applications, it is preferred that the Tear in the Cross Direction (CD) be higher than in the Machine Direction (MD). The films may have an Elmendorf Tear in the Machine Direction (MD) of lower than 100 g/mil, 60 g/mil or even 45 g/mil. In many applications, the Tear in the CD may be at least 60 g/mil, 70 g/mil or even 80 g/mil.

### Examples

In order to demonstrate the effectiveness of the present invention a series of 3 layer cast films are made. The films are made on a Davis Standard cast line with a 20 mil (about 500 microns) die gap, a set temperature of 500° F. (260° C.) on the core layer and 550° F. (about 288° C.) on the skin layers, a chill temp of 70° F. (about 21° C.), at an output of 400 lbs/hr (about 181 kg/hr) using the resins described on Table 1. The winding speed is adjusted to produce films of various thicknesses as reported in Table 2. The film structures are all A/B/A with each A layer being the same and representing the indicated amount by weight of the film, with the remainder being the B layer (or the second layer as described in the disclosure).

The following resins are used:

TABLE 1
PE materials characterization.

| | I2 @ 190° C. 2.16 kg | |
|---|---|---|
| | (g/10 min) | Density (g/cm3) |
| Resin A (MDPE) | 4.0 | 0.94 |
| Resin B (HDPE) | 1.02 | 0.961 |
| Resin C (HDPE) | 0.85 | 0.962 |
| Resin D (MDPE) | 0.85 | 0.94 |
| Resin E (LDPE) | 0.25 | 0.92 |
| Resin F (Random PP/PE | 7.0 (230° C.) | 0.900 |
| copolymer with about 6% by | | |
| weight of units derived from | | |
| ethylene monomer) | | |
| Resin G 70% Resin C/30% | | |
| CaCO₃) | | |

TABLE 2
Film structures

| | | | | Film layer | Total film |
|---|---|---|---|---|---|
| | Film Structures | | | distribution | thickness |
| | A | B | A | wt % A/B/A | mil |
| Inventive | 100% Resin A | 90% Resin | 100% Resin A | 20/60/20 | 7 |
| Example 1 | | B/10% | | | |
| | | Resin E | | | |
| Inventive | 100% Resin A | 90% Resin | 100% Resin A | 20/60/20 | 7 |
| Example 2 | | C/10% | | | |
| | | Resin E | | | |
| Inventive | 100% Resin D | 90% Resin | 100% Resin D | 20/60/20 | 7 |
| Example 3 | | D/10% | | | |
| | | Resin E | | | |
| Inventive | 100% Resin A | 90% Resin | 100% Resin A | 20/60/20 | 5 |
| example 4 | | C/10% | | | |
| | | Resin E | | | |
| Inventive | 100% Resin A | 90% Resin | 100% Resin A | 30/40/30 | 7 |
| example 5 | | C/10% | | | |
| | | Resin E | | | |
| Inventive | 85% Resin | 90% Resin | 85% Resin | 20/60/20 | 7 |
| Example 6 | A/15% Resin E | C/10% | A/15% Resin E | | |
| | | Resin E | | | |
| Comparative | 100% Resin F | 100% Resin F | 100% Resin F | 100 | 6 |
| Example 7 | | | | | |
| Comparative | 100% Resin F | 100% Resin F | 100% Resin F | 100 | 7 |
| Example 8 | | | | | |
| Comparative | 100% Resin G | 100% Resin G | 100% Resin G | 100 | 5 |
| Example 9 | | | | | |
| Comparative | 100% Resin G | 100% Resin G | 100% Resin G | 100 | 7 |
| Example 10 | | | | | |

Films properties of all 10 samples are presented on Table 3.

TABLE 3
Properties of cast films.

| | 2% | Tensile/ | Tensile/ | Tensile/ | | | |
|---|---|---|---|---|---|---|---|
| | Secant | Break | Strain | Stress | Tensile/Peak | | Elmendorf |
| | Modulus | Stress | at Yield | at Yield | Load | Gloss | Tear |
| | (CD) | (CD) | (CD) | (CD) | (CD) | (45°) | (CD/MD) |
| | (psi) | (psi) | (%) | (psi) | (lbf) | (%) | gf/mil |
| Inventive | 79700 | 3980 | 11 | 2820 | 30 | 40.2 | 74/39 |
| Example 1 | | | | | | | |
| Inventive | 79600 | 4390 | 12 | 2770 | 30 | 42.9 | 63/43 |
| Example 2 | | | | | | | |
| Inventive | 59500 | 4790 | 14 | 2310 | 36 | 47.3 | 152/96 |
| Example 3 | | | | | | | |
| Inventive | 83900 | 4170 | 11 | 2750 | 22 | 45.2 | 65/35 |
| Example 4 | | | | | | | |
| Inventive | 72700 | 4330 | 12 | 2620 | 29 | 44.3 | 60/46 |
| Example 5 | | | | | | | |
| Inventive | 78200 | 4240 | 12 | 2710 | 31 | 54.0 | 74/44 |
| Example 6 | | | | | | | |
| Comparative | 46500 | 4060 | 13 | 2570 | 26 | 44.0 | 58/60 |
| Example 7 | | | | | | | |
| Comparative | 52000 | 3910 | 14 | 2830 | 29 | 50.7 | 54/47 |
| Example 8 | | | | | | | |
| Comparative | 65400 | 1570 | 3 | 1620 | 9 | 16.9 | 85/24 |
| Example 9 | | | | | | | |
| Comparative | 76900 | 600 | 4 | 2410 | 18 | 20.9 | 78/38 |
| Example 10 | | | | | | | |

As seen in Table 3, inventive examples demonstrate that films with acceptable mechanical properties (including modulus, tear, and tensile) could be obtained by using HDPE resins (density of 0.940 g/cm³) or higher) with relatively high molecular weight (I₂<1.3 g/10 min) in the core layer and MDPE/HDPE resins with lower molecular weight in the outer layers. Compared to PP based films of comparable thickness, the films of the present invention show higher modulus. Compared to filled PE films of similar thickness, the films of the present invention show enhanced tensile properties. It is also observed that acceptable films are achieved even when the film is down gauged to 5 mil (inventive Example 4), and that the properties hold up better than the PP or filled PE films when those films are similarly down gauged.

It is specifically intended that the present disclosure not be limited to the embodiments and illustrations contained herein, but include modified forms of those embodiments including portions of the embodiments and combinations of elements of different embodiments as come within the scope of the following claims. It is further contemplated that the limitations set forth in the following dependent claims may be combined with limitations in any other dependent claim, mutatis mutandis.

1. A multilayer cast film suitable for use as a paper replacement comprising:
a. a first layer comprising a linear polyethylene having a density greater than 0.93 g/cm³ and a melt index greater than or equal to 2.0 g/10 min;
b. a second layer comprising a linear polyethylene having a density greater than 0.94 g/cm³ and a melt index less than or equal to 1.3 g/10 min
c. a third layer comprising a linear polyethylene having a density greater than 0.93 g/cm³ and a melt index greater than or equal to 2.0 g/10 min wherein the first layer and the third layer are each an external layer of the film, and wherein the film has been subjected to post-extrusion mono- or biaxial orientation and has an overall thickness of at least 125 microns.

2. The multilayer cast film of claim 1, wherein each external layer comprises the same linear polyethylene.

3. The multilayer cast film of claim 1 wherein the second layer comprises a linear polyethylene having a density greater than 0.95 g/cm³.

4. The multilayer cast film of claim 1 wherein the second layer comprises a linear polyethylene having a melt index less than or equal to 1.0 g/10 min.

5. The multilayer cast film of claim 1 wherein the first layer and/or the third layer comprises a linear polyethylene having a melt index greater than or equal to 3.0 g/10 min.

6. The multilayer cast film of claim 1 further comprising one or more additional polymers in second layer, wherein the additional polymer comprises less than 50% by weight of the second layer.

7. The multilayer cast film of claim 6 wherein the additional polymer is a low density polyethylene.

8. (canceled)

9. The multilayer cast film of claim 1 wherein the film contains less than five percent filler by weight of the film.

10. The multilayer cast film of claim 1 wherein said film has a 2% secant modulus in the machine direction of at least 300 MPa.

11. The multilayer cast film of claim 1 wherein said film has an Elmendorf Tear in the machine direction of 50 g/mil or less.

12. The multilayer cast film of claim 1 wherein said film has an Elmendorf Tear in the cross direction of 60 g/mil or greater.

13. The multilayer cast film of claim 1 wherein said film has a gloss 45° greater than 70%.

14. The multilayer cast film of claim 1 wherein the density of the linear polyethylene used in the second layer is higher than the density of the linear polyethylene used in either the first layer or the third layer.

15. The multilayer cast film of claim 14 where the density of the linear polyethylene is at least 0.001 g/cm³ higher than the density of the linear polyethylene used in either the first layer or the third layer.
